(19) United States
(12) Patent Application Publication
(10) Pub. No.: US 2001/0042301 A1
(43) Pub. Date: Nov. 22, 2001

(54) A METHOD OF FABRICATING A DISK DRIVE

(76) Inventor: HONG KHUU, FREMONT, CA (US)

Correspondence Address: MARK D BARRISH, TOWNSEND AND TOWNSEND AND CREW, EIGHTH FLOOR, TWO EMBARCADERO CENTER, SAN FRANCISCO, CA, 941113834

(21) Appl. No.: 08/971,033

(22) Filed: Nov. 14, 1997

(51) Int. Cl. G11B 5/127; H04R 31/00

(52) U.S. Cl. 29/603.03; 29/757; 360/97.01; 269/903

(57) ABSTRACT

The invention provides an improved support structure for the components of a removable hard disk drive system, particularly for use in recording and archiving of digital video and other data. The invention generally makes use of a base formed by stamping sheet metal. This stamping process can be used to define cartridge engaging surfaces within the base, as well as mounting pads for the data transfer head support structure, spindle drive structure, a head load ramp, and the like.

### BACKGROUND OF THE INVENTION

The present invention is generally related to recording systems for digital video and other data, and in particular, provides a low cost sheet metal base structure which accurately aligns the various components of the disk drive system, together with methods and tools for production of disk drives having such sheet metal bases.

Video Cassette Recorders (“VCRs”) dominate the consumer video market, due in part to their combination of low cost and recording capabilities. VCR analog magnetic tape recording cassettes can be used to record, play-back, and store video images in a format which is well adapted for use with existing analog television signals. The ability to record allows consumers to use the standard VHS VCR to save television shows and home movies, as well as for play-back of feature films.

The structure of VCR systems and recording media are adapted to record and archive existing television signals. Specifically, a large amount of analog data is presented on a standard television screen during a standard length feature film. VCR systems record this analog data using analog recording media. The VCR recordings can be removed from the recording/play-back equipment for storage, thereby minimizing the system costs when large numbers of movies are stored.

While VCR systems successfully provide recording and archive capabilities at low cost, these existing consumer video systems have significant disadvantages. For example, accessing selected portions of a movie stored on a VCR tape can be quite slow. In particular, the cassette must be rewound to the beginning of the movie between each showing, which can involve a considerable delay. Additionally, transferring data to and from the tape takes a substantial amount of time. Although it would be beneficial to provide high speed accessing and transfer of the video data, this has remained a secondary consideration, as movies are typically recorded and played by the consumer in real time. Alternatives providing faster access are commercially available (for example, optical video disks), but these alternatives generally have not been able to overcome the VCR's low cost and recording capabilities.

Recent developments in video technology may further decrease the VCR's advantages over alternative systems. Specifically, standard protocols have recently been established for High Definition TeleVision (“HDTV”) signals. The digital data presented in a single HDTV feature film using these protocols can represent a substantial increase over existing VCR system capacities. While digital video cassette tapes are available, these modified versions of existing analog VCR systems do not appear to have sufficient storage capacity for a feature film in all of the proposed HDTV formats. Optical disks can accommodate these larger quantities of digital data. Unfortunately, despite many years of development, a successful low cost optical recording system has remained an elusive goal.

Personal computer magnetic data storage systems have evolved with structures which are quite different than consumer video storage systems. Modern personal computers often include a rigid magnetic disk which is fixed in an associated disk drive. These hard disk drive systems are adapted to access and transfer data to and from a recording surface at high speeds. It is generally advantageous to increase the total data storage capacity of each hard disk, as the disks themselves are typically fixed in the drive system. Hence, much of the data that is commonly used by the computer is stored on a single disk.

The simplicity provided by such a fixed disk drive system helps maintain overall system reliability, and also helps reduce the overall storage system costs. Nonetheless, removable hard disk cartridge systems have recently become commercially available, and are now gaining some acceptance. While considerable computer data can be stored using these removable hard disk cartridge systems, their complexity, less than ideal reliability, and cost has limited their use to selected numbers of high-end personal computer users.

One particular disadvantage of known removable hard disk computer storage systems is the cost of the structure used to maintain alignment between the various disk drive components. The disk generally spins within the cartridge housing, and a data transfer head of the drive is selectively positioned along a recording surface of the disk. Any contact between the disk and the cartridge housing, or between the movable structure (which positions and supports the data transfer head) and the disk or the cartridge housing may interfere with the operation of the disk system. Such contact could even result in catastrophic damage of the recording surface or disk drive components.

To maintain the desired alignment of the disk, cartridge, and head support structure, the structure of existing removable disk drives often include a base which is precisely machined. Unfortunately, while such machined base structures can very accurately position the spindle drive motor, data transfer head support structure, cartridge, and the like, the cost of these fairly complex, precisely machined support structures adds significantly to the total drive system cost.

In light of the above, it would be desirable to provide improved data storage systems, devices, and methods for storing digital video and other data. It would be particularly desirable if these improved systems, devices and methods were adapted for digital video data such as the new HDTV protocols, and had the ability to record, archive, and access digital feature films with good speed and reliability, and at a low system cost to the consumer. It would be especially desirable to provide alternative structures which are capable of providing the desired alignment between the components of a removable hard disk drive system, but at a lower cost than those of known machined removable hard disk drive bases.

### SUMMARY OF THE INVENTION

The present invention provides an improved support structure for the components of a removable hard disk drive system, particularly for use in recording and archiving of digital video and other data. In contrast to the machine base structures of known removable hard disk systems, the present invention makes use of a base formed by stamping sheet metal. This stamping process can be used to define cartridge engaging surfaces within the base, as well as mounting pads for the data transfer head support structure, spindle drive structure, a head load ramp, and the like. As the stamped base of the present invention can be fabricated using an economical progressive stamping operation with very little wasted material, such a base might be fabricated at a cost which is roughly one order of magnitude less than known machined bases for removable hard disk drive structures.

In a first aspect, the present invention provides a disk drive system for use with digital video and other data. The system comprises a removable cartridge having a rigid recording disk disposed within a cartridge housing. The disk drive has a receptacle which receives the cartridge, the receptacle defined at least in part by a base. The base supports a data transfer head and a spindle drive, and comprises stamped sheet metal. Preferably, the base primarily comprises stamped sheet metal, the base ideally being substantially composed of stamped steel.

In another aspect, the present invention provides a disk drive for use with a removable cartridge. The removable cartridge includes a recording disk and a cartridge housing with positioning surfaces. The disk drive comprises a housing having a receptacle which receives the cartridge. The housing includes a base housing portion which at least in part defines the receptacle. The base supports a data transfer head and a spindle drive and has positioning surfaces which engage the positioning surfaces of the cartridge to position the cartridge within the receptacle. The base comprises stamped sheet metal.

In a method according to the present invention, sheet metal is stamped to form a disk drive base, and a head positioning mechanism and spindle drive mechanism are mounted to stamped surfaces of the base. Stamped positioning surfaces of the base are engaged by a removable cartridge so as to align the cartridge with the head positioning and spindle drive mechanisms.

In another aspect, the present invention provides a method for designing a disk drive. The method comprises providing a three-dimensional model of the cartridge which includes a rigid disk within a disk cartridge housing. A three-dimensional model of a plurality of disk drive components are also provided. The disk drive components include a data transfer head and a drive motor. The three-dimensional models of the cartridge and components are combined, and the combined models are used to develop a sheet metal support structure which accurately positions the cartridge and components relative to each other.

In yet another aspect, the present invention provides a tool for stamping a base of a disk drive. The tool comprises a first tool portion and a second tool portion. The first tool portion has a plurality of cartridge positioning surfaces which are positioned relative to each other so as to correspond to engageable surfaces of a removable cartridge. The first tool portion further comprises a plurality of drive component positioning surfaces. The second tool portion is matable with the first tool portion. The second tool portion has a plurality of stamping surfaces which are adapted to press sheet metal against the cartridge positioning surfaces and drive component positioning surfaces of the first tool portion when the tool portions are pressed toward each other with the sheet metal disposed therebetween.

In another aspect, the present invention provides a method for assembling a disk drive. The disk drive will be used with disks having spindles, and the method comprises positioning a disk drive base against a tool. A disk drive motor is positioned against the tool by engaging a spindle of the tool with a chuck of the motor. The positioned motor is bonded to the positioned base. Preferably, the chuck magnetically engages the spindle of the tool to hold the motor in position such that there is a gap between the base and motor. Adhesive cured within this gap will maintain the position of the motor relative to the base after both are released from the tool.

### BRIEF DESCRIPTION OF THE DRAWINGS

FIG. 1 is a schematic illustration of a video system including a high definition television and an external disk drive.

FIG. 1A is a perspective view of an external disk drive for use with a removable rigid recording disk cartridge, according to the principles of the present invention.

FIG. 1B is a perspective view of an internal disk drive similar to the external drive of FIG. 1, in which the internal drive is adapted for insertion into a standard bay of a computer.

FIG. 2 is a perspective view of the internal disk drive of FIG. 1B, in which a cover of the disk drive has been removed to show a receptacle for the removable cartridge and some of the major disk drive components.

FIG. 3 is a perspective view of a removable cartridge housing a rigid magnetic recording disk.

FIG. 3A is an alternative perspective view of the cartridge of FIG. 3, showing the door and door actuation mechanism.

FIG. 4 is a simplified perspective view of the internal drive of FIG. 2, in which the voice coil motor and arm have been removed to show the cartridge release linkage and the head retract linkage.

FIG. 5A is a top view of a base for the internal drive of FIG. 2, in which the base is substantially entirely formed from sheet stock in a single stamping process.

FIG. 5B is a front view of the base of FIG. 5A.

FIG. 5C schematically illustrates a method for forming the stamped sheet metal base using a progressive stamping toolset.

FIG. 6A is a top view of the internal drive of FIG. 1B, in which the cover has been removed to show insertion of the cartridge of FIG. 3 therein.

FIG. 6B is a cross-sectional side view of the cartridge being inserted into the internal drive of FIG. 1B.

FIG. 7A is a cross-sectional side view of the cartridge of FIG. 3 fully inserted into the internal drive of FIG. 1B.

FIG. 7B is a top view of the cartridge inserted within the drive.

FIG. 8 is an exploded perspective view showing a method for assembling the internal drive of FIG. 1B.

### DESCRIPTION OF THE PREFERRED EMBODIMENT

The devices, systems, and methods of the present invention generally make use of low cost, stamped sheet metal support structures in disk drive systems having removable hard disk cartridges. Stamped sheet metal can provide cartridge positioning surfaces, insertion guide surfaces, and component mounting pads at a fraction of the cost of a machined disk drive base. The cartridges used with these disk drives will preferably contain a single two-sided rigid magnetic recording disk which is capable of storing at least about 2.4 gigabytes of data, ideally being capable of storing at least about 4.7 gigabytes of data. These devices and methods will find applications for storing a wide variety of data for use with notebook computers, desktop computers, and more powerful computer workstations. The cartridges, the disk drive systems, and the fabrication tools and methods of the present invention are particularly well suited for use in recording, archiving, and playing back digital video data, for fabricating video storage systems. Due to the low cost, large capacity, and archivability provided by the recording system of the present invention, a standard length movie in a format suitable for high definition television “HDTV” may be stored using no more than two cartridges, and ideally may be stored on a single cartridge having a single, two sided hard disk.

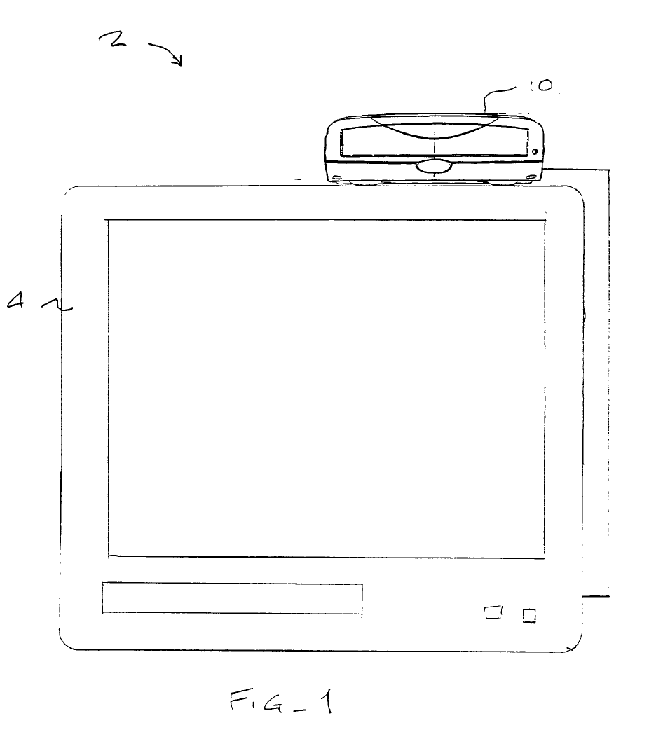

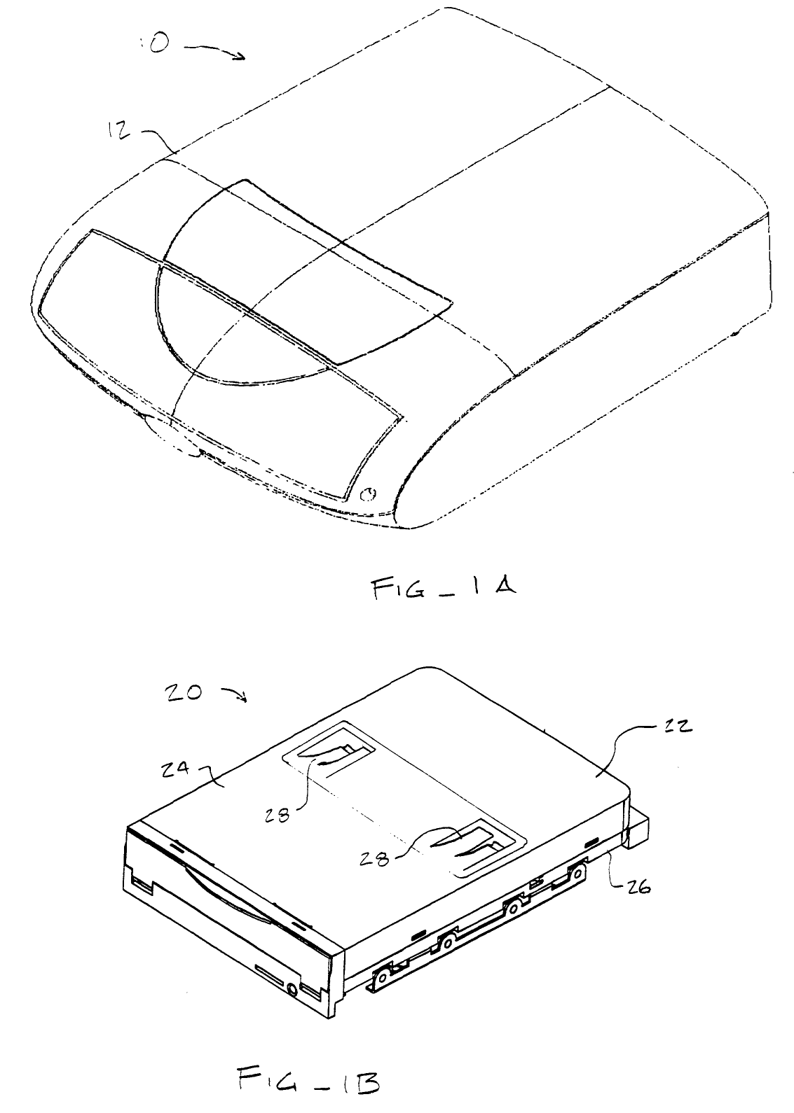

As schematically illustrated in FIG. 1, a video system 2 includes a high definition television 4 which is coupled to an external disk drive 10. External drive 10 will read recorded digital data from a removable disk cartridge, and will transmit that data to HDTV 4, preferably using one of the standard digital formats or protocols now being established. No general purpose computer need be coupled between external drive 10 and HDTV 4, although such a general purpose computer may be incorporated into video system 2 to allow flexible manipulation of the video data. In the exemplary embodiment, external drive 10 is less than 2 in. by less than 5½% in. by less than 7 in. The small size of the drive (and the small size of the disks on which the movies are stored) helps decrease the overall space which is required for video systems and the associated movie library.

Referring now to FIGS. 1A and 1B, external disk drive 10 and internal disk drive 20 will share many of the same components. However, external drive 10 will include an enclosure 12 adapted for use outside a personal computer, high definition television, or some other data manipulation or display device. Additionally, external drive 10 will include standard I/O connectors, parallel ports, and/or power plugs similar to those of known computer peripheral or video devices.

Internal drive 20 will typically be adapted for insertion into a standard bay of a computer. In some embodiments, internal drive 10 may instead be used within a bay in a HDTV, thereby providing an integral video system. Internal drive 20 may optionally be adapted for use with a bay having a form factor of 2.4 inches, 1.8 inches, 1 inch, or with any other generally recognized or proprietary bay. Regardless, internal drive 20 will typically have a housing 22 which includes a housing cover 24 and a base plate 26. As illustrated in FIG. 1B, housing 24 will typically include integral springs 28 to bias the cartridge downward within the receiver of housing 22. It should be understood that while external drive 10 may be very different in appearance than internal drive 20, the external drive will preferably make use of base plate 26, cover 24, and most or all mechanical, electromechanical, and electronic components of internal drive 20.

Many of the components of internal drive 20 are visible when cover 22 has been removed, as illustrated in FIG. 2. In this exemplary embodiment, a voice coil motor 30 positions first and second heads 32 along opposed recording surfaces of the hard disk while the disk is spun by spindle drive motor 34. A release linkage 36 is mechanically coupled to voice coil motor 30, so that the voice coil motor effects release of the cartridge from housing 22 when heads 32 move to a release position on a head load ramp 38. Head load ramp 38 is preferably adjustable in height above base plate 26, to facilitate aligning the head load ramp with the rotating disk.

A head retract linkage 40 helps to ensure that heads 32 are retracted from the receptacle and onto head load ramp 38 when the cartridge is removed from housing 22. Head retract linkage 40 may also be used as an inner crash stop to mechanically limit travel of heads 32 toward the hub of the disk.

Base 26 preferably comprise a steel sheet metal structure in which the shape of the base is primarily defined by stamping, the shape ideally being substantially fully defined by a progressive stamping process. Bosses 42 are stamped into base 26 to engage and accurately position lower surfaces of the cartridge housing. To help ensure accurate centering of the cartridge onto spindle drive 34, rails 44 maintain the cartridge above the associated drive spindle until the cartridge is substantially aligned axially above the spindle drive, whereupon the cartridge descends under the influence of cover springs 28 and the downward force imparted by the user. This brings the hub of the disk down substantially normal to the disk into engagement with spindle drive 34. A latch 46 of release linkage 36 engages a detent of the cartridge to restrain the cartridge, and to maintain the orientation of the cartridge within housing 22.

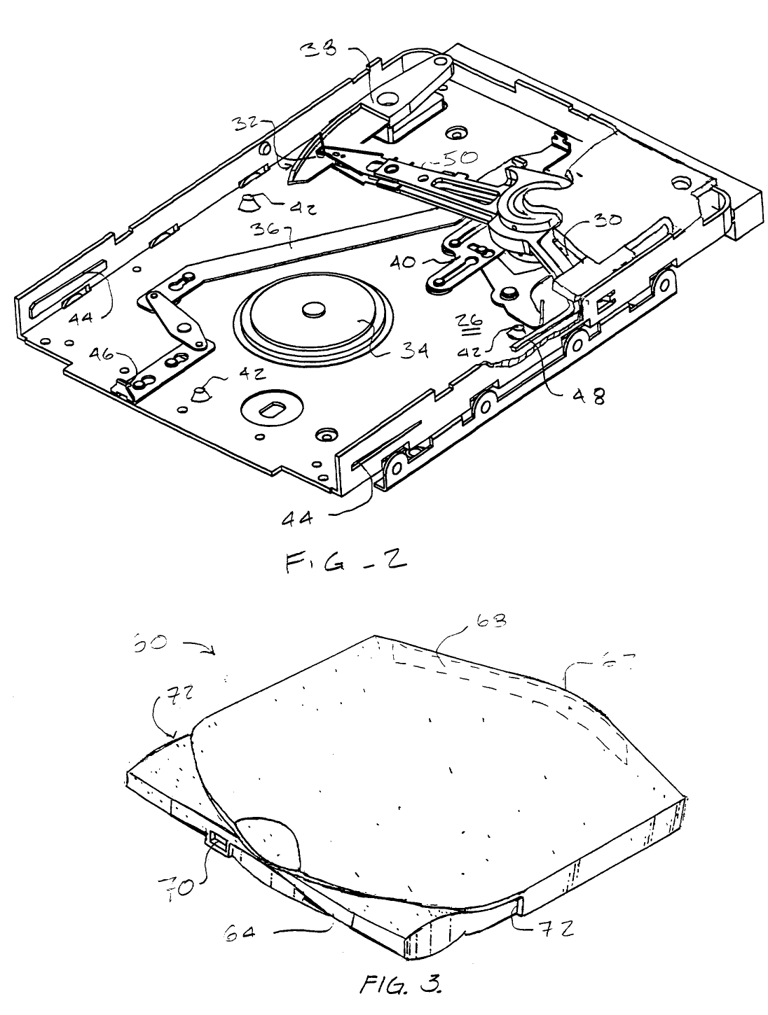

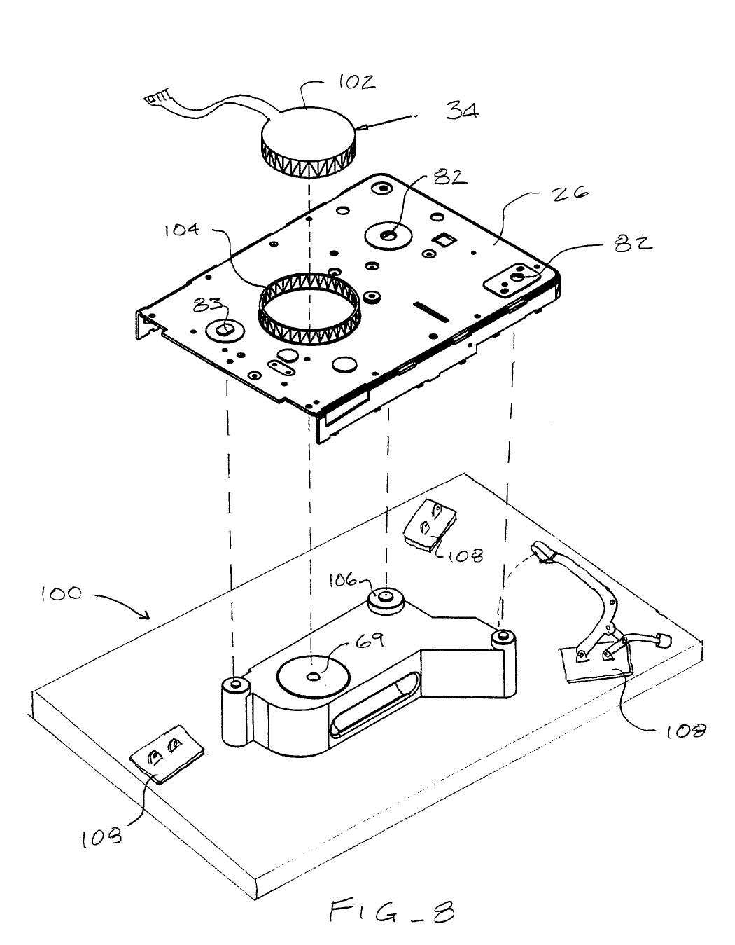

A cartridge for use with internal drive 20 is illustrated in FIGS. 3 and 3A. Generally, cartridge 60 includes a front edge 62 and rear edge 64. A disk 66 (see FIG. 7B) is disposed within cartridge 60, and access to the disk is provided through a door 68. A detent 70 along rear edge 64 of cartridge 60 mates with latch 46 to restrain the cartridge within the receptacle of the drive, while rear side indentations 72 are sized to accommodate side rails 44 to allow cartridge 60 to drop vertically into the receptacle. Optionally, a ridge may extend from rear edge of the cartridge to facilitate insertion and/or removal of the cartridge, and to avoid any interference between the housing surrounding the receptacle and the user's fingers. The door of the drive may include a corresponding bulge to accommodate such a ridge. An anti-rattle mechanism, ideally having a two-part arm (one portion comprising polymer molded integrally with the door, the other portion comprising a metal and extending from the polymer portion over the hub of the disk) prevents the disk from rattling within the cartridge when the cartridge is removed from the drive. The anti-rattle mechanism is more fully described in co-pending U.S. patent application Ser. No. ______ (Attorney Docket No. 18525-000900), filed concurrently herewith, the full disclosure of which is incorporated herein by reference.

Side edges 74 of cartridge 60 are fittingly received between side walls 76 of base 26, as illustrated in FIG. 4. This generally helps maintain the lateral position of cartridge 60 within base 26 throughout the insertion process. Stops 78 in sidewall 76 stop forward motion of the cartridge once the hub of disk 66 is aligned with spindle drive 34, at which point rails 44 are also aligned with rear indents 72. Hence, the cartridge drops roughly vertically from that position, which helps accurately mate the hub of the disk with the spindle drive.

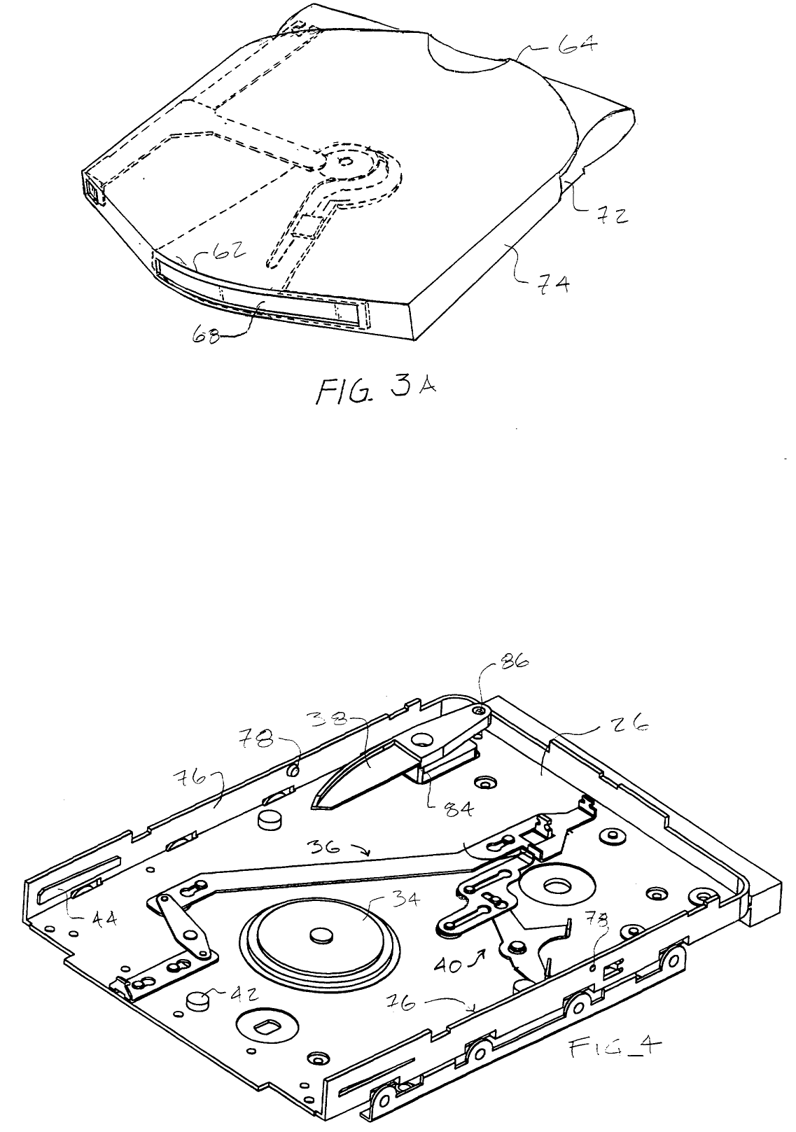

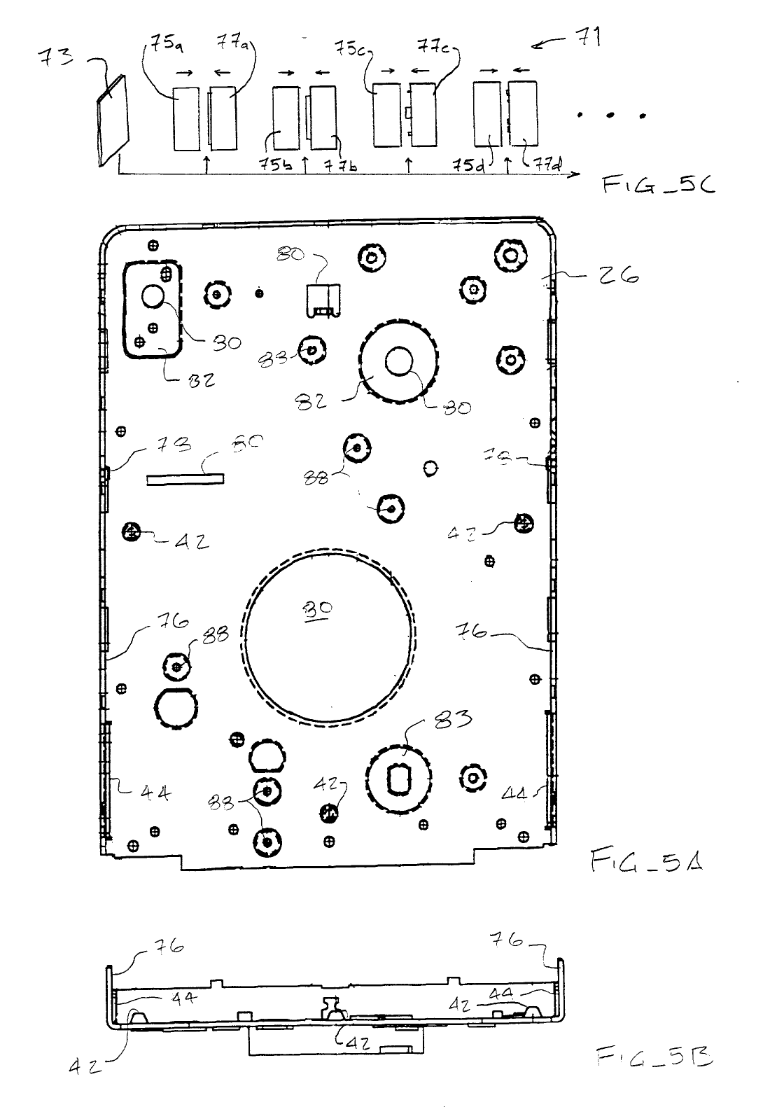

The structure of base 26 can be seen most clearly in FIGS. 4, 5A, and 5B. Base 26 generally comprises a stamped sheet metal structure, ideally being formed of cold-rolled 1018 steel that has been treated to prevent corrosion. Openings 80 accommodate the spindle drive, data transmission cables, component mounting fasteners, and the like. Openings 80 are substantially formed during the stamping process, but may optionally be modified afterward to provide threaded openings, etc. Mounting pads 82 are also generally defined by the stamp tools, so that head load ramp 38, the head support structure (which generally includes voice coil motor 30 and head support arm 50, as illustrated in FIG. 2), and spindle drive 34 are substantially located relative to each other. Mounting pads 82 and a reference pad 83 will also be used to align spindle drive motor 34, as described hereinbelow.

Bosses 42 and side wall 76 are also formed by clamping the sheet metal stock between male and female tool parts during the progressive stamping process, while side rails 44 and stops 78 may be formed by independently movable tool portions. The cartridge engaging surfaces and component mounting pads may even be positioned on base 26 simultaneously during the relatively rapid stamping process, rather than individually machining each of these surfaces.

A method for forming base 26 using a progressive tool 71 is illustrated in FIG. 5C. Sheet stock 73 (ideally comprising cold-rolled 1018 steel) is stamped between male tool parts 75a, b, . . . and female tool parts 77a, b . . . . The male and female tool parts have corresponding surfaces which engage the opposed sides of the sheet metal to shear the sheet stock to shape, shear a spindle drive opening through the base and form the spindle drive mounting wall, form mounting and reference pads, and the like. This process may make use of more than 10 individual tools.

Once base 26 is stamped to shape, the various components may be mounted to the base to assemble the disk drive. Spindle drive 34 will be bonded to the base material which extends downward from its associated opening 80, as will be described in detail with reference to FIG. 8. Voice coil motor 30 and arm 50, which together support head 32 (see FIG. 2) are mounted directly to their associated pad 82. The driving member or “chuck” of spindle drive 34 will rotate about a fixed position, rather than telescoping axially to engage the disk within the cartridge. The position of the spindle drive assembly and/or voice coil motor may optionally be adjusted during assembly using a gauge to align the disk on the spindle drive with the motion of heads 32.

Head load ramp 38 is also mounted on an associated stamped pad 82 of base 26. The head load ramp will preferably flex about a central fulcrum 84. This facilitates adjustment of a height of the head load ramp over the base using a rear screw 86, as more fully described in co-pending U.S. patent application Ser. No. ______, filed concurrently herewith (Attorney Docket No. 18525-000800) and assigned to the present assignee, the full disclosure of which is incorporated herein by reference. This allows the height of the head load ramp adjacent the disk to be easily adjusted so as to smoothly transfer the heads between the recording surface and a “park” position along the head load ramp.

Also formed during the stamping process are linkage mounts 88. Release linkage 36 and head retract linkage 40 will be mounted to linkage mounts 88 using rivets or other fasteners which accommodate the sliding and/or pivoting of the linkage members, as appropriate.

Heads 32 will often be separated from the spinning recording surface by a thin layer of air. More specifically, the data transfer head often glides over the recording surface on an “air bearing,” a thin layer of air which moves with the rotating disk. Although recording densities are generally enhanced by minimizing the thickness of this air bearing (often referred to as the “glide height”), glide heights which are too low may lead to excessive contact between the head and the disk surface, which can decrease the reliability of the recording system. To avoid a head crash (in which the data transfer head contacts and damages the disk), the disk drive system of the present system will generally position heads 32 on head load ramp 38 whenever the disk is rotating at insufficient velocity to maintain a safe glide height.

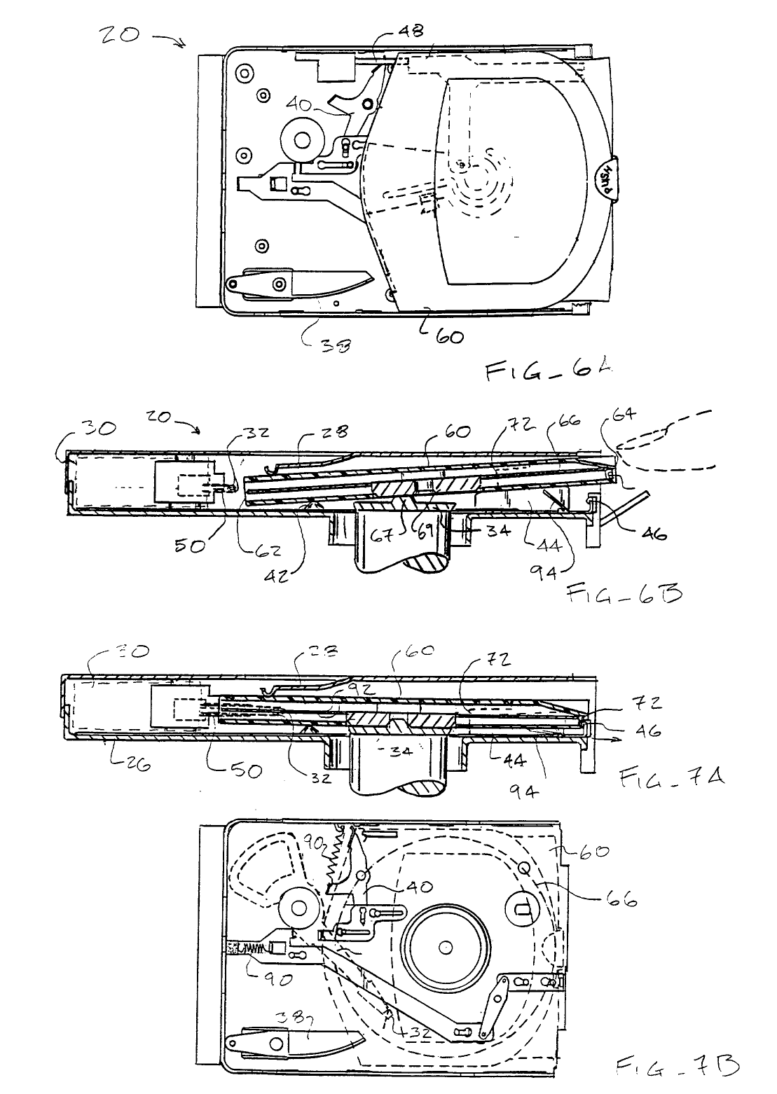

Referring now to FIGS. 6A-7B, arm 50 pivotably supports heads 32. When no cartridge is disposed in internal drive 20 and no power is supplied to voice coil motor 30, biasing springs of head retract linkage 40 and release linkage 36 urge arm 50 to a parked position on head load ramp 38. As cartridge 60 is inserted into the receptacle of internal drive 20, the cartridge actuates head retract linkage 40 so that the voice coil motor is free to pivot the arm from the parked position.

During insertion, cover springs 28 urge forward edge 62 of cartridge 60 downward, while rear edge 64 remains elevated (so long as the cartridge rides along rails 44) as cartridge 60 slides into the receiver, biasing spring 90 attached to head retract linkage 40 is tensioned. Biasing spring 102 is generally overcome manually during insertion of the cartridge.

Once cartridge 60 is inserted so that disk 66 is substantially aligned axially with spindle drive 34, rear side indentations 72 (see FIG. 3) allow rear edge 64 of the cartridge to drop downward below rails 44. This downward movement is opposed by base springs 94. These base springs generally comprise simple wire structures screwed or otherwise fastened to base 26, and the upward urging force imposed on cartridge 60 by the base springs is again manually overcome during insertion.

As base springs 94 are compressed against base 26, latch 46 slides into detent 80, so that the latch restrains cartridge 60 within the receiver of internal drive 20. Simultaneously, spindle drive 34 aligns with and engages the spindle at the hub of disk 66, with centering alignment and driving engagement between the spindle drive and the disk generally being facilitated by a protruding, tapering nose on a magnetic chuck 67 of the spindle drive and a corresponding counter sunk spindle 69 at the hub of disk 66.

As described hereinabove, the door of the cartridge opens automatically during insertion of the cartridge. Actuation of head retract linkage 40 during insertion also frees arm 50 to move heads 32 from head load ramp 38 to recording surfaces 92 along the major surfaces of disk 66.

While cartridge 60 is disposed within the receptacle of drive 20, the position of the cartridge is generally maintained by engagement between the surfaces of the cartridge and the stamped surfaces of base 26. More specifically, cover springs 28 and latch 46 hold cartridge 60 in contact with bosses 42, thereby ensuring alignment between the major surfaces of the cartridge and the disk drive structure. The fore and aft position of the cartridge is generally maintained by engagement between side rails 44 and rear indentation 72, with head retract linkage 40 biasing these two elements against each other. As described above, the sidewalls of base 26 fittingly receive side edges of cartridge 60, so that the position of the cartridge within the receptacle is substantially fully constrained. The tolerance of the positioning of the cartridge within drive 20 should be sufficient so that the disk can rotate freely within the cartridge housing when supported by the chuck of the spindle drive, and so that the heads (as supported by the head support structure) have free access to the recording surfaces of the disk.

As described above, cartridge 60 is held in the receiver of internal drive 20 by engagement of latch 46 with detent 70. Voice coil motor 30 may effect release of the cartridge by engagement between a tab of arm 50 and a corresponding tab on release linkage 36. Expulsion of the disk from the receptacle of internal drive 20 is effected after the disk has spun down with heads 32 safely parked along head load ramp 38. Voice coil motor 30 actuates release linkage 36 so as to disengage latch 46 from detent 80.

When the latch is disengaged, engagement between rails 44 and indents 72 initially prevents the cartridge from sliding along the plane of the disk. Instead, base springs 94 urge rear edge 64 of cartridge 60 upward, disengaging spindle drive 34 substantially axially from the hub of the disk. Once these driving structures are safely disengaged, biasing spring 90 of head retract linkage 40 urges cartridge 60 out of the receiver, and the head retract linkage also ensures that arm 50 is safely positioned with heads 32 along head load ramp 38. Generally, the biasing system will slide the cartridge rearward so that a portion of the cartridge extends from the drive, and so that the cartridge can be easily manually removed and replaced by the user.

A preferred method for designing a disk drive base can be understood with reference to FIGS. 2, 4, 6A and 7B. According to this method, three-dimensional models of cartridge 60 (including disk 66) and internal drive 20 (including head load ramp 38, arm 50 with heads 32, and the like) are provided and combined to develop a sheet metal base 26 which constrains and supports the cartridge and components relative to each other with sufficient accuracy.

An assembly tool 100 and method for mounting of spindle drive 34 onto base 26 is illustrated in FIG. 8. Spindle drive 34 generally includes a drive motor 102 and a magnetic chuck 67 (See FIG. 6B). An exemplary motor is manufactured by Sanyo Seiki of Japan. Base 26 includes mounting pads 82 for the head load ramp and voice coil motor (which in turn supports the data transfer heads), and also includes a spindle drive mounting wall 104. Assembly tool 100 is used to accurately align the motor with these stamped component support structures of the base so that the motor can be adhesively bonded to the mounting wall at the proper position.

Assembly tool 100 includes highly accurate positioning surfaces 106 having a tolerance of less than 0.001 inch, the positioning surfaces ideally having a tolerance of about 0.0002 inches. Positioning surfaces are positioned to engage mounting pads 82 and reference pad 83 of base 26. Clamps 108 (only one of which is shown complete for clarity) are associated with positioning surfaces 106, and the positioning surfaces and clamps fully and accurately constrain the base relative to assembly tool 100.

Assembly tool 100 further includes a countersunk spindle 69. Spindle 69 is also accurately positioned relative to positioning surfaces 106, and may be integrated into the surrounding tool structure, or may comprise a separately formed part which is attached to the remaining tool. Regardless, as described above regarding engagement of the hub of the disk with the chuck within the disk cartridge, the magnetic chuck of the motor and the disk spindle have corresponding engagement surfaces. The magnetic attraction between the chuck and the disk spindle, together with the accurate engagement of their surfaces, helps the disk to align itself on the motor. Assembly tool 100 takes advantage of this capability in reverse, using the self-alignment interaction of the magnetic chuck and tool spindle 69 to position the motor on the tool.

In use, assembly tool 100 engages base 26 so that the base sits securely on the tool. In some embodiments, the tool may be lowered onto the upright base, and the base and tool can be turned over together. Clamps 108 securely hold mounting pads 82 and reference pad 83 against the associated positioning surfaces 106. Spindle drive 34 (including motor 102 and the magnetic chuck) is then gently placed in the opening bordered by mounting wall 104. The magnetic chuck of spindle drive 34 will magnetically engage spindle 69 of assembly tool 100, holding the motor in the proper orientation relative to mounting pads 82.

A gap between the cylindrical mounting wall 104 and a corresponding cylindrical surface of the motor helps ensure that the base does not interfere with the positioning of spindle drive. Adhesive can also be introduced into this gap to affix spindle drive 34 to base 26 in the proper position. Adhesive bonding has the advantage that the motor is not damaged by heat, and the use of adhesive within a gap allows the motor and base to be fabricated with looser tolerances than direct engagement between machined surfaces, for example. In the exemplary embodiment, 2 drops of a commercially available adhesive (sold under the trademark Loctite 6050®) is introduced in each of 3 evenly spaced locations about the toroidal gap. Ultraviolet light is then used to cure the adhesive, ideally using 3 intervals of 20 seconds each. The bonded spindle drive and base can then be released from the tool, and the adhesive will maintain the position of the magnetic chuck relative to the mounting pads, and to the disk drive components which are subsequently mounted thereon.

While the exemplary embodiment has been described in some detail, by way of example and for clarity of understanding, a variety of modifications, changes, and adaptations will be obvious to those of skill in the art. Therefore, the scope of the present invention is limited solely by the appended claims.

What is claimed is:

1. A disk drive system for use with digital video and other data, the system comprising:
a removable cartridge having a rigid recording disk disposed within a cartridge housing;
a disk drive having a receptacle which receives the cartridge, the receptacle defined at least in part by a base, the base supporting a data transfer head and a spindle drive, the base comprising stamped sheet metal.

2. A system as claimed in claim 1, wherein the system is adapted for playing a movie.

3. A disk drive for use with a removable cartridge, the removable cartridge including a recording disk and a cartridge housing with positioning surfaces, the disk drive comprising;
a housing having a receptacle which receives the cartridge, the housing including a base housing portion which at least in part defines the receptacle, the base supporting a data transfer head and a spindle drive and having positioning surfaces which engage the positioning surfaces of the cartridge to position the cartridge within the receptacle, the base comprising stamped sheet metal.

4. A disk drive as claimed in claim 3, wherein the base is substantially composed of stamped steel.

5. A disk drive as claimed in claim 3, wherein the disk drive is adapted to transfer data between the head and a recording surface of the disk when the recording surface is aligned along a reference plane and rotated about an axis of the spindle drive, and wherein the positioning surfaces of the disk drive comprise fixed stamped features which can orient the cartridge within the receptacle so that the disk is rotatable about the spindle axis within the cartridge when the recording surface is aligned with the reference plane.

6. A disk drive as claimed in claim 5, wherein the base further comprises fixed stamped guide surfaces which are adapted to slidingly engage the cartridge housing to direct the cartridge into the receptacle.

7. A disk drive as claimed in claim 3, wherein the data transfer head is mounted to the base with a head positioning mechanism, wherein the spindle drive is mounted to the head with a spindle motor mechanism, and further comprising a head load ramp which is mounted to the base to support the head when no cartridge is disposed in the receptacle, wherein the base further comprises mounting pads which support the head positioning mechanism, spindle motor mechanism, and the head load ramp, the mounting pads being stamped surfaces.

8. A method comprising;
stamping sheet metal to form a disk drive base;
mounting a head positioning mechanism and a spindle drive mechanism to stamped surfaces of the base; and
engaging stamped positioning surfaces of the base with a removable cartridge so as to align a disk within the cartridge with the head positioning and spindle drive mechanisms.

9. A method for designing a disk drive, the method comprising:
providing a three-dimensional computer model of a cartridge including a rigid disk within a disk cartridge housing;
providing a three-dimensional computer model of a plurality of disk drive components, the disk drive components including a data transfer head and a drive motor;
combining the three-dimensional computer models of the cartridge and components and using the combined models to develop a sheet metal support structure which accurately positions the cartridge and components relative to each other.

10. A tool for stamping a base of a disk drive, the tool comprising:
a first tool portion, the first tool portion having a plurality of cartridge positioning surfaces, the positioning surfaces being approximately positioned relative to each other so as to correspond to engageable surfaces of a removable cartridge, the first tool portion further comprising a plurality of drive component positioning surfaces;
a second tool portion matable with the first tool portion, wherein the second tool portion has a plurality of stamping surfaces which are adapted to press sheet metal against the cartridge positioning surfaces and drive component positioning surfaces of the first tool portion when the second tool portion is pressed toward the first tool portion with the sheet metal disposed therebetween.

11. A method for assembling a disk drive, the disk drive for use with disks having spindles, the method comprising:
positioning a disk drive base against a tool;
positioning a disk drive motor assembly against the tool by engaging a spindle of the tool with a chuck of the motor; and
bonding the positioned motor to the positioned base.

12. A method as claimed in claim 11, wherein the chuck of the motor comprises a magnetic chuck, and wherein the motor positioning step comprises placing the motor near the spindle, the magnetic chuck magnetically holding the motor in alignment with the base.

13. A method as claimed in claim 11, wherein the base positioning step comprises engaging at least one reference surface of the tool with a stamped surface of the base, the base comprising stamped sheet metal.

14. A method as claimed in claim 11, wherein the bonding step comprises curing adhesive within a gap between the positioned base and the positioned motor.
